(19) United States
(12) Patent Application Publication
(10) Pub. No.: US 2016/0311991 A1
(43) Pub. Date: Oct. 27, 2016

(54) LOW-OILING COATED POLYCARBONATE FILMS

(71) Applicant: Covestro Deutschland AG, Leverkusen (DE)

(72) Inventors: Serguei KOSTROMINE, Swisttal-Buschhoven (DE); Joachim PETZOLDT, Monheim (DE)

(21) Appl. No.: 14/897,707

(22) PCT Filed: Jun. 11, 2014
(86) PCT No.: PCT/EP2014/062085

§ 371 Date: Dec. 11, 2015

(30) Foreign Application Priority Data
Jun. 14, 2013 (EP) 13172192.0

(51) Int. Cl. C08J 7/04; B05D 3/06; C09D 133/12

(52) U.S. Cl. CPC C08J 7/047; C09D 133/12; B05D 3/067; C08J 2369/00; C08J 2433/12

(57) ABSTRACT

The present invention relates to a coated polycarbonate film coated with at least one polymethylmethacrylate-containing layer, comprising a polycarbonate film beneath at least one polymethylmethacrylate-containing layer having a polymethylmethacrylate content of at least 40% by weight, characterized in that the total layer thickness of the at least one polymethylmethacrylate-containing layer is at least 10 μm, the uppermost layer of the at least one polymethylmethacrylate-containing layer is obtainable by coating with a coating composition comprising at least one polymethylmethacrylate polymer or polymethylmethacrylate copolymer having a mean molar mass Mw of at least 100 000 g/mol in a content of at least 40% by weight of the solids content of the coating composition; at least one UV-curable reactive diluent in a content of at least 30% by weight of the solids content of the coating composition; at least one photoinitiator in a content of 0.1 to 10 parts by weight of the solids content of the coating composition; and at least one organic solvent, where the proportion of ethylenically unsaturated groups is at least 3 mol per kg of the solids content of the coating composition.

The present invention relates to a polycarbonate film coated with at least one polymethylmethacrylate-containing layer, the surface of which has improved properties in terms of scratch resistance, solvent resistance and anti-oiling characteristics, and to a production process for such a film. The present invention further relates to 3D plastics parts comprising the inventive film, and to the use of the inventive films for production of plastics parts in film insert moulding processes.

Film insert moulding technology has become established for the production of plastics parts in the injection moulding process. It involves first two- or three-dimensionally prefabricating the frontal surface of a part from a coated film and then tilling or insert moulding it with a polymer melt from the reverse side.

It is often desirable that the front side has sufficient protection from chemical and mechanical effects. This is often achieved in the prior art by an appropriate coating or paint system on the surface. In order to avoid wet coating of the finished three-dimensional parts, it is advantageous that such a paint or coating system should already have been applied to the film which then runs through all the further forming steps with the film and is then ultimately cured, for example by UV exposure.

This gives rise to a very specific profile of properties for coated films which suit this technology. In the prior art, the term “formable hardcoating” has become established for this product class, meaning a film coating which is at first sufficiently blocking-resistant, but then can be thermally formed as desired together with the substrate and at the end receives the properties of a protective layer through UV curing.

Such a combination of properties, in the sense of blocking resistance and thermoplastic characteristics of the primary coating, together with the great latent potential for UV crosslinking, is difficult to implement.

Most of the approaches to a solution for this objective in the prior art comprise the use of macromonomers which are prepared principally by dual-cure processes, as described inter alia in Beck, Erich (BASF), Scratch resistant UV coatings for automotive applications, Pitture e Vernici, European Coatings (2006), 82(9), 10-19; Beck, Erich, Into the third dimension: three ways to apply UV coating technology to 3D-automotive objects, European Coatings Journal (2006), (4), 32, 34, 36, 38-39; Petzoldt, Joachim; Coloma, Fermin (BMS), New three-dimensionally formable hardcoat films, JOT, Journal fuer Oberflaechentechnik (2010), 50(9), 40-42; EP 2113527 A1, Petzoldt et al., Development of new generation hardcoated films for complex 3D-shaped FIM applications, RadTech Asia 2011, Conference Proceedings.

The insert moulding of these film products with, for example, polycarbonate melt (film insert moulding) results in the desired plastics parts.

High demands are made on the visual appearance of such plastics parts, which find wide use in automobiles, in all other modes of transport, electrical and electronic devices, and in the construction industry. Irregular rainbow phenomena, often referred to as “oiling”, mar the visual impression desired. This unwanted effect is a particularly serious consideration when plastics parts are to be produced in glossy piano black.

The “oiling” effect arises through interference of two light beams reflected in one direction, one beam being reflected at the air/coating interface, while the other beam is reflected at the coating/substrate film interface beneath. The more light is reflected by the two surfaces, the more visible the effect can become. Glossy paint films on glossy substrates are a prerequisite for severe oiling. Exactly this case occurs when, for example, a smooth polycarbonate film is covered with a shiny clearcoat material.

In such an application, smooth polycarbonate films having a refractive index of about 1.58 are often used, which are generally coated with an aliphatic-based coating material in an application-relevant coating thickness between 5 and 20 μm. As a result of thermal forming, the layer thickness of the coating on the component is also varied in a location-dependent manner, which can promote the development of a rainbow effect on the component overall.

Overall, there is thus an increased need for polycarbonate films having a low-oiling surface which additionally has adequate blocking resistance before and after the forming process, and has a certain scratch resistance and solvent resistance after curing by means of UV light, for example. The fulfilment of such a profile of properties with the combination of properties mentioned constitutes a particular challenge to the person skilled in the art.

It has been found that, surprisingly, thermally formable and subsequently UV-curable coated polycarbonate films having exceptional scratch resistance and solvent resistance can be realized in a particularly efficient manner, even in low-“oiling” form, when the polycarbonate substrate is covered with at least one polymethylmethacrylate-containing layer, the total thickness of the layer or of the layers together being at least 10 μm and this layer or each of these layers including at least 40% by weight of polymethylmethacrylate, and a coating composition for the entire layer or for the uppermost layer of the PMMA-containing coating comprising at least one polymethylmethacrylate polymer or polymethylmethacrylate copolymer having a weight-average molar mass of at least 100 000 g/mol, at least one UV-curable reactive diluent, at least one photoinitiator and at least one solvent.

The present invention therefore provides the following: A coated polycarbonate film comprising a polycarbonate film beneath at least one polymethylmethacrylate-containing layer having a polymethylmethacrylate content of at least 40% by weight, characterized in that
the total layer thickness of the at least one polymethylmethacrylate-containing layer is at least 10 μm,
the uppermost layer of the at least one polymethylmethacrylate-containing layer is obtainable by coating with a coating composition comprising
   (a) at least one polymethylmethacrylate polymer or polymethylmethacrylate copolymer having a mean molar mass Mw of at least 100 000 g/mol in a content of at least 40% by weight of the solids content of the coating composition;
   (b) at least one UV-curable reactive diluent in a content of at least 30% by weight of the solids content of the coating composition;
   (c) at least one photoinitiator in a content of ≧0.1 to ≦10 parts by weight of the solids content of the coating composition; and
   (d) at least one organic solvent,
   where the proportion of ethylenically unsaturated groups is at least 3 mol per kg of the solids content of the coating composition.

The PMMA-containing coating may thus be homogeneous and may have been applied in one layer. It may also consist of a plurality of PMMA-containing layers which have been applied in succession. As described above, the PMMA-containing layers of the at least one PMMA-containing layer may have different compositions. The prerequisites for this include the minimum proportion of PMMA of 40% by weight for each layer, the particular composition of the coating composition for the uppermost layer, and the total layer thickness of PMMA-containing layers of the at least one PMMA-containing layer of at least 10 μm. If only one PMMA-containing layer is intended, the PMMA layer having a layer thickness of at least 10 μm consists of a coating obtainable by coating with the inventive coating composition.

Therefore, in the simplest embodiment, the coated polycarbonate film according to the present invention consists of a polycarbonate film and a coating which has been obtained by coating the film with the coating composition according to the invention. In this way, it is possible in a highly efficient manner to arrive at an inventive polycarbonate film having a low-oiling, scratch-resistant and solvent-resistant surface.

Likewise advantageous is a two-layer cover of the polycarbonate substrate having a total thickness of at least 10 μm, in which case the lower layer directly adjoining the polycarbonate consists of pure polymethylmethacrylate and the upper layer is obtainable from the inventive coating composition. Thus, the inventive coated polycarbonate film, in this preferred embodiment, comprises two polymethylmethacrylate-containing layers. In a preferred configuration thereof, the inventive film comprises a polycarbonate/polymethylmethacrylate film obtainable by co-extrusion, and a coating obtainable by coating with the coating composition according to the present invention on the polymethylmethacrylate layer of the film.

Polycarbonate/polymethylmethacrylate co-extruded films having polymethylmethacrylate layers of different thickness are known in the prior art and a variety are commercially available, for example from Bayer Materialscience AG under the Makrofol® SR 253, Makrofol® SR 906, Makrofol® SR 280 trade names. Films of this kind can serve for production of the inventive films, by being coated with the inventive coating composition on the polymethylmethacrylate side such that the PMMA-containing total layer thickness is at least 10 μm.

Many of the co-extruded PC/PMMA films mentioned which are commercially available and in the prior art already have a PMMA layer having a thickness of more than 10 μm. On substrates of this kind, even a very thin inventive coating, for example in a thickness 5 μm, does not lead to any significant oiling because the refractive indices of PMMA and the inventive coating, which consists for the most part of PMMA, are very close to one another. This new interface does not cause any enhancement of the unwanted rainbow phenomenon.

The number of PMMA-containing layers overall is thus at least 1, and may be 1, 2, 3 or 4 in total. At the same time, the inventive layer thickness of the PMMA-containing layers is at least 10 μm. According to the number and thickness of the PMMA-containing layers, the uppermost PMMA-containing layer obtainable by coating with the inventive coating composition may have a thickness of at least 2 μm, preferably at least 5 μm and more preferably at least 10 μm. The thickness of the abovementioned co-extruded PMMA layer in a co-extruded PC/PMMA film may be at least 10 μm, preferably at least 15 μm and more preferably at least 20 μm. Thus, the thickness of the PMMA layer in a co-extruded PC/PMMA film may be at least 10 μm, and the thickness of the layer obtainable from the inventive coating composition thereon may be at least 5 μm.

The inventive coating composition can be obtained in a simple and efficient manner. Furthermore, coatings obtainable thereby have adequate blocking resistance on many surfaces such as, more particularly, the films considered for use in the film insert moulding process, but can then be thermally formed as desired together with the coated substrate and receive a surface having advantageous properties in terms of scratch resistance, solvent resistance and an at least reduced oiling effect after curing by means of UV radiation, for example.

The determination of the scratch resistance can be determined, for example, using the pencil hardness, as measurable on the basis of ASTM D 3363. An assessment of solvent resistance can be made on the basis of EN ISO 2812-3:2007. It is remarkable that the surface of the moulding obtained by the inventive coating of the film with the coating composition and final curing by UV radiation has very good durability, even with respect to acetone, a solvent which is otherwise very harmful to polycarbonate surfaces.

A measure used for the rainbow effect, which defines oiling, is the number of Newton rings determined from reflection spectra. It is calculated from the maximum amplitude in the reflection spectrum between 400 nm and 650 nm. Reflection (R) and maximum amplitude (MA) are taken from the spectrum in per cent. In order to eliminate the unit, MA is divided by R at the same wavelength. In order to avoid decimal places, the value determined is multiplied by 1000. The values thus determined are below 20 for inventive coatings, whereas comparative films having obvious oiling exhibit values of 30 and above or even higher.

The coating composition according to the present invention comprises
(a) at least one polymethylmethacrylate polymer or polymethylmethacrylate copolymer having a mean molar mass Mw of at least 100 000 g/mol in a content of at least 40% by weight of the solids content of the coating composition;
(b) at least one UV-curable reactive diluent in a content of at least 30% by weight of the solids content of the coating composition;
(c) at least one photoinitiator in a content of ≧0.1 to ≦10 parts by weight of the solids content of the coating composition; and
(d) at least one organic solvent,

where the proportion of ethylenically unsaturated groups is at least 3 mol per kg of the solids content of the coating composition.

Polymethylmethacrylate (PMMA) is understood to mean polymethylmethacrylate homopolymers and methyl methacrylate-based copolymers, preferably having a methyl methacrylate content of more than 70% by weight. PMMA polymers and PMMA copolymers of this kind are known and commercially available under the trade names Degalan®, Degacryl®, Plexyglas®, Acrylite® (manufacturer: Evonik), Altuglas, Oreglas (manufacturer: Arkema), Evacite®, Colacryl®, Lucite® (manufacturer: Lucite).

Preference is given to PMMA homopolymers and copolymers composed of 70% by weight to 99.5% by weight of methyl methacrylate and 0.5% by weight to 30% by weight of methyl acrylate, more preferably of 90% by weight to 99.5% by weight of methyl methacrylate and 0.5% by weight to 10% by weight of methyl acrylate. The Vicat softening temperatures VET to ISO 306 are preferably at least 95° C. and are more preferably in the range from 100° C. to 115° C.

The mean molecular weight Mw of the PMMA homopolymers and copolymers for use in the coating composition in accordance with the invention is at least 100 000 g/mol, more preferably at least 150 000 g/mol and more preferably at least 200 000 g/mol.

The molecular weight Mw can be determined, for example, by gel permeation chromatography or by the scattered light method (see, for example, H. F. Mark et al., Encyclopedia of Polymer Science and Engineering, 2nd edition, vol. 10, pages 1 ff., J. Wiley, 1989).

The PMMA homopolymer or copolymer is an essential part of the inventive coating composition and of the inventive coating. The proportion of the PMMA homopolymer or copolymer in the solids content of the coating composition is preferably at least 40% by weight, more preferably at least 45% by weight and most preferably at least 50% by weight.

Reactive diluents usable with preference as component (b) of the inventive coating composition are bifunctional, trifunctional, tetrafunctional, pentafunctional or hexafunctional acrylic and/or methacrylic monomers. Preference is given to ester functions, especially acrylic ester functions. Suitable polyfunctional acrylic and/or methacrylic esters derive from aliphatic polyhydroxyl compounds having at least 2, preferably at least 3 and more preferably at least 4 hydroxyl groups, and preferably 2 to 12 carbon atoms.

Examples of such aliphatic polyhydroxyl compounds are ethylene glycol, propylene glycol, butane-1,4-diol, hexane-1,6-diol, diethylene glycol, triethylene glycol, glycerol, trimethylolpropane, pentaerythritol, dipentaerythritol, tetramethylolethane and sorbitan. Examples of esters of said polyhydroxyl compounds, said esters being suitable with preference in accordance with the invention as bi- to hexafunctional acrylic and/or methacrylic monomers for the reactive diluent, are glycol diacrylate and dimethacrylate, butanediol diacrylate or dimethacrylate, dimethylolpropane diacrylate or dimethacrylate, diethylene glycol diacrylate or dimethacrylate, divinylbenzene, trimethylolpropane triacrylate or trimethacrylate, glyceryl triacrylate or trimethacrylate, pentaerythrityl tetraacrylate or tetramethacrylate, dipentaerythrityl penta-/hexaacrylate (DPHA), butane-1,2,3,4-tetraol tetraacrylate or tetramethacrylate, tetramethylolethane tetraacrylate or tetramethacrylate, 2,2-dihydroxypropane-1,3-diol tetraacrylate or tetramethacrylate, diurethane dimethacrylate (UDMA), sorbitan tetra-, penta- or hexaacrylate or the corresponding methacrylates. It is also possible to use mixtures of crosslinking monomers having two to four or more ethylenically unsaturated, free-radically polymerizable groups.

Additionally in accordance with the invention, it is possible to use, as reactive diluents or components b) of the inventive coating composition, alkoxylated di-, tri-, tetra-, penta- and hexaacrylates or -methacrylates. Examples of alkoxylated diacrylates or -methacrylates are alkoxylated, preferably ethoxylated, methanediol diacrylate, methanediol dimethacrylate, glyceryl diacrylate, glyceryl dimethacrylate, neopentyl glycol diacrylate, neopentyl glycol dimethacrylate, 2-butyl-2-ethylpropane-1,3-diol diacrylate, 2-butyl-2-ethylpropane-1,3-diol dimethacrylate, trimethylolpropane diacrylate or trimethylolpropane dimethacrylate.

Examples of alkoxylated triacrylates or -methacrylates are alkoxylated, preferably ethoxylated, pentaerythrityl triacrylate, pentaerythrityl trimethacrylate, glyceryl triacrylate, glyceryl trimethacrylate, butane-1,2,4-triol triacrylate, butane-1,2,4-triol trimethacrylate, trimethylolpropane triacrylate, trimethylolpropane trimethacrylate, tricyclodecanedimethanol diacrylate, tricyclodecanedimethanol dimethacrylate, ditrimethylolpropane tetraacrylate or ditrimethylolpropane tetramethacrylate.

Examples of alkoxylated tetra-, penta- or hexaacrylates are alkoxylated, preferably ethoxylated, pentaerythrityl tetraacrylate, dipentaerythrityl tetraacrylate, dipentaerythrityl pentaacrylate, dipentaerythrityl hexaacrylate, pentaerythrityl tetramethacrylate, dipentaerythrityl tetramethacrylate, dipentaerythrityl pentamethacrylate or dipentaerythrityl hexamethacrylate.

In the alkoxylated diacrylates or -methacrylates, triacrylates or -methacrylates, tetraacrylates or -methacrylates, pentaacrylates or -methacrylates and/or alkoxylated hexaacrylates or -methacrylates in component b), all the acrylate groups or methacrylate groups or only some of the acrylate groups or methacrylate groups in the respective monomer may be bonded to the corresponding radical via alkylene oxide groups. It is also possible to use any desired mixtures of such wholly or partly alkoxylated tri-, tetra-, penta- or hexaacrylates or -methacrylates. In this case, it is also possible that the acrylate or methacrylate group(s) is/are bonded to the aliphatic, cycloaliphatic or aromatic radical of the monomer via a plurality of successive alkylene oxide groups, preferably ethylene oxide groups. The mean number of alkylene oxide or ethylene oxide groups in the monomer is stated by the alkoxylation level or ethoxylation level. The alkoxylation level or ethoxylation level may preferably be from 2 to 25, particular preference being given to alkoxylation levels or ethoxylation levels of 2 to 15, most preferably of 3 to 9.

Likewise in accordance with the invention, reactive diluents or components b) of the inventive coating composition may be oligomers which belong to the class of the aliphatic urethane acrylates or of the polyester acrylates or polyacryloylacrylates. The use thereof as paint binders is known and is described in Chemistry & Technology of UV & EB Formulation for Coatings, Inks & Paints, vol. 2, 1991, SITA Technology, London (P. K. T. Oldring (ed.) on p. 73-123 (Urethane Acrylates) and p. 123-135 (Polyester Acrylates). Commercially available examples which are suitable within the inventive context include aliphatic urethane acrylates such as Ebecryl® 4858, Ebecryl® 284, Ebecryl® 265, Ebecryl® 264, Ebecryl® 8465, Ebecryl® 8402 (each manufactured by Cytec Surface Specialities), Craynor® 925 from Cray Valley, Viaktin® 6160 from Vianova Resin, Desmolux VP LS 2265 from Bayer MaterialScience AG, Photomer 6891 from Cognis, or else aliphatic urethane acrylates dissolved in reactive diluents, such as Laromer® 8987 (70% in hexanediol diacrylate) from BASF AG, Desmolux U 680 H (80% in hexanediol diacrylate) from Bayer MaterialScience AG, Craynor® 945B85 (85% in hexanediol diacrylate), Ebecryl® 294/25HD (75% in hexanediol diacrylate), Ebecryl® 8405 (80% in hexanediol diacrylate), Ebecryl® 4820 (65% in hexanediol diacrylate) (each manufactured by Cytec Surface Specialities) and Craynor® 963B80 (80% in hexanediol diacrylate), each from Cray Valley, or else polyester acrylates such as Ebecryl® 810, 830, or polyacryloylacrylates such as Ebecryl®, 740, 745, 767 or 1200 from Cytec Surface Specialities.

In a further preferred embodiment, the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaaacrylates and/or pentamethacrylates, alkoxylated hexaacrylates and/or hexamethacrylates, aliphatic urethane acrylates, polyester acrylates, polyacryloylacrylates and mixtures thereof.

In a further preferred embodiment, the reactive diluent (b) of the inventive coating composition comprises dipentarythrityl penta-/hexaacrylate.

The invention also encompasses mixtures of the abovementioned crosslinking multifunctional monomers with multifunctional monomers such as, more particularly, methyl methacrylate. The proportion of the multifunctional monomers in such a mixture is preferably at least 20% by weight.

The reactive diluent is an essential part of the inventive coating composition and of the inventive coating. The proportion of the at least one reactive diluent in the solids content of the coating composition is at least 30% by weight, preferably at least 40% by weight, more preferably at least 45% by weight.

The content of ethylenically unsaturated groups has a significant influence on the achievable durability properties of the radiation-cured coating. Therefore, the inventive coating composition contains a content of ethylenically unsaturated groups of at least 3.0 mol per kg of solids content of the coating composition, preferably at least 3.5 mol per kg, more preferably at least 4.0 mol per kg of solids content of the coating composition. This content of ethylenically unsaturated groups is also well known to the person skilled in the art by the term “double bond density”.

The term “at least one photoinitiator” in the inventive coating composition encompasses the standard, commercially available compounds known to those skilled in the art, for example α-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacylphosphine oxide and others, said photoinitiators being utilizable alone or in combination of two or more or in combination with one of the above polymerization initiators.

UV photoinitiators used may, for example, be IRGACURE® products from BASF, for example the products IRGACURE® 184, IRGACURE® 500, IRGACURE® 1173, IRGACURE®2959, IRGACURE® 745, IRGACURE® 651, IRGACURE® 369, IRGACURE® 907, IRGACURE® 1000, IRGACURE® 1300, IRGACURE® 819, IRGACURE® 819DW, IRGACURE® 2022, IRGACURE® 2100, IRGACURE® 784, IRGACURE® 250; in addition, the DAROCUR® products from BASF are used, for example the products DAROCUR® MBF, DAROCUR® 1173, DAROCUR® TPO, DAROCUR® 4265. Another example of a UV photoinitiator usable in the inventive coating composition can be purchased under the Esacure One trade name from the manufacturer Lamberti.

Photoinitiators are present in the coating composition at in the range from ≧0.1 to ≦10 parts by weight of the solids content of the coating composition.

The coating composition should additionally contain, over and above the 100 parts by weight of components (a), (h) and (c), one or more organic solvents.

Suitable solvents are particularly those that do not attack polycarbonate polymers. Such solvents are preferably alcohols. In a preferred embodiment of the present invention, the solvent (d) is selected from 1-methoxy-2-propanol, diacetone alcohol, 2,2,3,3-tetrafluoropropanol and mixtures thereof Very particular preference is given to 1-methoxy-2-propanol.

The coating material composition thus preferably contains, in addition to the 100 parts by weight of components (a), (b) and (c), 0 to 900 parts by weight, more preferably 100 to 850 parts by weight, most preferably 200 to 800 parts by weight, of the at least one organic solvent.

The coating composition may additionally optionally contain, over and above the 100 parts by weight of components (a), (b) and (c), one or more further coatings additives. Such coatings , additives may be selected, for example, from the group comprising stabilizers, levelling agents, surface additives, pigments, dyes, inorganic nanoparticles, adhesion promoters, UV absorbers, IR absorbers, preferably from the group comprising stabilizers, levelling agents, surface additives and inorganic nanoparticles. The paint composition preferably contains, in addition to the 100 parts by weight of components (a), (b) and (c), 0 to 40 parts by weight, more preferably 0 to 30 parts by weight, most preferably 0.1 to 20 parts by weight, of at least one further coatings additive. Preferably, the total proportion of all the coatings additives present in the coating material composition is 0 to 40 parts by weight, more preferably 0 to 30 parts by weight, most preferably 0.1 to 20 parts by weight.

The coating material composition may comprise inorganic nanoparticles to increase the mechanical durability, for example scratch resistance and/or pencil hardness.

Useful nanoparticles include inorganic oxides, mixed oxides, hydroxides, sulphates, carbonates, carbides, borides and nitrides of elements of main group II to IV and/or elements of transition group I to VIII of the Periodic Table, including the lanthanides. Preferred nanoparticles are silicon oxide, aluminium oxide, cerium oxide, zirconium oxide, niobium oxide, zinc oxide or titanium oxide nanoparticles, particular preference being given to silicon oxide nanoparticles.

The particles used preferably have mean particle sizes (measured by means of dynamic light scattering in dispersion, determined as the Z-average) of less than 200 nm, preferably of 5 to 100 nm, more preferably 5 to 50 nm. Preferably at least 75%, more preferably at least 90%, even more preferably at least 95%, of all the nanoparticles used have the sizes defined above.

The coating composition can be produced in a simple manner by first of all dissolving the polymer completely in the solvent at room temperature or at elevated temperatures and then the other obligatory and any optional components to the solution which has been cooled to room temperature, either combining them in the absence of solvent(s) and mixing them together by stirring, or in the presence of solvent(s), for example adding them to the solvent(s), and mixing them together by stirring. Preferably, first the photoinitiator is dissolved in the solvent(s) and then the further components are added. This is optionally followed by a purification by means of filtration, preferably by means of fine filtration.

Because of its excellent impact resistance with simultaneous transparency, polycarbonate can also be used in the context of the present invention as a thermoplastic polymer for insert moulding or filling of the 3D-formed film coated with the protective layer in a film insert moulding process for production of a 3D moulding or plastics part. In a likewise preferred embodiment of the present invention, the thermoplastic polymer thus comprises polycarbonate. Polycarbonates and polycarbonate formulations, and also polycarbonate films, suitable for the invention are obtainable, for example, under the Makrolon®, Bayblend® and Makroblend® trade names (Bayer MaterialScience).

Suitable polycarbonates for the production of the inventive polycarbonate compositions are all the known polycarbonates. These are homopolycarbonates, copolycarbonates and thermoplastic polyester carbonates. The suitable polycarbonates preferably have mean molecular weights M̅_{w} of 18 000 to 40 000, preferably of 26 000 to 36 000 and especially of 28 000 to 35 000, determined by measuring the relative solution viscosity in dichloromethane or in mixtures of equal weights of phenol/o-dichlorobenzene, calibrated by light scattering.

The polycarbonates are preferably prepared by the interfacial process or the melt transesterification process, which have been described many times in the literature. With regard to the interfacial process, reference is made by way of example to H. Schnell, Chemistry and Physics of Polycarbonates, Polymer Reviews, vol. 9, Interscience Publishers, New York 1964 S. 33 ff., to Polymer Reviews, vol. 10, “Condensation Polymers by Interfacial and Solution Methods”, Paul W. Morgan, Interscience Publishers, New York 1965, ch. VIII, p. 325, to Drs. U. Grigo, K. Kircher and P. R- Muller “Polycarbonate” [Polycarbonates] in Becker/Braun, Kunststoff-Handbuch [Polymer Handbook], volume 3/1, Polycarbonate, Polyacetale, Polyester, Celluloseester [Polycarbonates, Polyacetals, Polyesters, Cellulose Esters], Carl Hanser Publishers, Munich, Vienna, 1992, p. 118-145, and to EP-A 0 517 044. The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and U.S. Pat. No. B 6,228,973.

The polycarbonates can be obtained from reactions of bisphenol compounds with carbonic acid compounds, especially phosgene, or diphenyl carbonate or dimethyl carbonate in the melt transesterification process. Particular preference is given here to homopolycarbonates based on bisphenol A and copolycarbonates based on monomers bisphenol A and 1,1-bis(4-hydroxyphenyl)-3,3,5-trimethylcyclohexane. Further bisphenol compounds which can be used for the polycarbonate synthesis are disclosed, inter alia, in WO-A 2008037364, EP-A 1 582 549, WO-A 2002026862, WO-A 2005113639

The polycarbonates may be linear or branched. It is also possible to use mixtures of branched and unbranched polycarbonates.

Suitable branching agents for polycarbonates are known from the literature and are described, for example, in patent specifications U.S. Pat. No. B 4,185,009, DE-A 25 00 092, DE-A 42 40 313, DE-A 19 943 642, U.S. Pat. No. B 5,367,044 and in literature cited therein. Furthermore, the polycarbonates used may also be intrinsically branched, in which case no branching agent is added in the course of polycarbonate preparation. One example of intrinsic branches is that of so-called Fries structures, as disclosed for melt polycarbonates in EP-A 1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

The polymer composition(s) of the film or of the thermoplastic polymer of the 3D moulding may additionally comprise additives, for example UV absorbers, IR absorbers and other customary processing aids, especially demoulding agents and fluxes, and also the customary stabilizers, especially thermal stabilizers, and also antistats, pigments, colourants and optical brighteners. In every layer, different additives or concentrations of additives may be present.

The present invention further provides a process for producing the coated polycarbonate film, comprising the steps of

(i) coating a polycarbonate film or a co-extruded polycarbonate/polymethylmethacrylate film with a coating composition comprising
(a) at least one polymethylmethacrylate polymer or polymethylmethacrylate copolymer having a mean molar mass Mw of at least 100 000 g/mol in a content of at least 40% by weight of the solids content of the coating composition;
(b) at least one UV-curable reactive diluent in a content of at least 30% by weight of the solids content of the coating composition;
(c) at least one photoinitiator in a content of 0.1 to 10 parts by weight of the solids content of the coating composition; and
(d) at least one organic solvent,
where the proportion of ethylenically unsaturated groups is at least 3 mol per kg of the solids content of the coating composition.

(ii) drying the coating;

(iii) optionally cutting the film to size and/or delaminating, printing and/or thermally or mechanically forming the film;

(iv) irradiating the coating with UV radiation to cure the coating,

where the thickness of the at least one PMMA-containing layer after the drying step is at least 10 μm.

In this context, the coating composition with its constituents and the term “films” are the same ones which have already been elucidated in the context of the present invention, in combination with one another as well,

The film can be coated with the coating composition by the standard methods for coating films with fluid coating compositions, for example by knife-coating, spraying, pouring, flow-coating, dipping, rolling or spin-coating. The flow-coating process can be effected manually with a hose or suitable coating head, or automatically in a continuous run by means of flow-coating robots and optionally slot dies. Preference is given to the application of the coating composition by a roll-to-roll transfer. In this case, the surface of the film to be coated may be pretreated by cleaning or activation.

The drying follows the application of the coating composition to the film. For this purpose, more particularly, elevated temperatures in ovens, and moving and optionally also dried air, for example in convection ovens or by means of nozzle dryers, and thermal radiation such as IR and/or NIR, are employed. In addition, it is possible to use microwaves. It is possible and advantageous to combine a plurality of these drying processes. The drying of the coating in step preferably comprises flash-off at room temperature and/or elevated temperature, such as preferably at 20-200° C., more preferably at 40-120° C. After the coating has been dried, it is blocking-resistant, and so the coated substrate, especially the coated film, can be laminated, printed and/or thermally formed. Forming in particular is preferred in this context, since merely the forming of a coated film here can define the mould for film insert moulding process for production of a three-dimensional plastics part.

Advantageously, the conditions for the drying are selected such that the elevated temperature and/or the thermal radiation does not trigger any polymerization (crosslinking) of the acrylate or methacrylate groups, since this can impair formability. In addition, the maximum temperature attained should appropriately be selected at a sufficiently low level that the film does not deform in an uncontrolled manner.

After the drying/curing step, the coated film, optionally after lamination with a protective film on the coating, can be rolled up. The film can be rolled up without the coating sticking to the reverse side of the substrate film or of the laminating film. However, it is also possible to cut the coated film to size and to send the cut sections individually or as a stack to further processing. Particular preference is given in this context to the thermal forming of the coated film to a three-dimensional mould, as undertaken as a preparatory step for insert moulding of the film with a thermoplastic polymer such as polycarbonate in a film insert moulding process. In a preferred embodiment, step (iii) comprises the cutting-to-size and thermal forming of the coated film.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiative curing is preferably effected by the action of high-energy radiation, i.e. UV radiation or daylight, for example light of wavelength ≧200 nm to ≦750 nm, or by irradiation with high-energy electrons (electron beams, for example ≧90 keV to ≦300 keV). The radiation sources used for light or UV light are, for example, moderate- or high-pressure mercury vapour lamps, wherein the mercury vapour may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≧80 mJ/cm² to ≦5000 mJ/cm².

In a preferred embodiment, the actinic radiation is therefore light in the UV light range.

The irradiation can optionally be performed with exclusion of oxygen, for example under inert gas atmosphere or reduced-oxygen atmosphere. Suitable inert gases are preferably nitrogen, carbon dioxide, noble gases or combustion gases. In addition, the irradiation can be effected by covering the coating with media transparent to the radiation. Examples thereof are polymer films, glass or liquids such as water.

According to the radiation dose and curing conditions, the type and concentration of any initiator used can be varied or optimized in a manner known to those skilled in the art or by exploratory preliminary tests. For curing of the formed films, it is particularly advantageous to conduct the curing with several emitters, the arrangement of which should be selected such that every point on the coating receives substantially the optimal radiation dose and intensity for curing. More particularly, unirradiated regions (shadow zones) should be avoided.

In addition, according to the film used, it may be advantageous to select the irradiation conditions such that the thermal stress on the film does not become too great. In particular, thin films and films made from materials having a low glass transition temperature can have a tendency to uncontrolled deformation when a particular temperature is exceeded as a result of the irradiation. In these cases, it is advantageous to allow a minimum level of infrared radiation to act on the substrate, by means of suitable filters or a suitable design of the emitters. In addition, reduction of the corresponding radiation dose can counteract uncontrolled deformation. However, it should be noted that a particular dose and intensity in the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. In that case, photoinitiators are used in concentrations of ≦0.1% by weight to ≦10% by weight, more preferably of ≧0.2% by weight to ≦3.0% by weight, based on the solids content of the coating. These coatings are preferably cured using a dose of ≧80 mJ/cm² to ≦5000 mJ/cm².

Insert moulding of the coated film with a thermoplastic polymer, such as polycarbonate, on-completion of curing of the film coating and the optional, usually desirable, forming of the coated film is well known to the person skilled in the art in the form of the film insert moulding process as described, for example, in WO 2004/082926 A1 and WO 02/07947 A1. In a preferred embodiment of the process according to the invention, the reverse coating of the film in a step (v) is effected by means of extrusion or injection moulding, preferably with polycarbonate melt. The processes of extrusion and of injection moulding for this purpose are well known to those skilled in the art and are described, for example, in “Handbuch Spritzgieβen” [Injection Moulding Handbook], Friedrich Johannnaber/Walter Michaeli, Munich; Vienna: Hanser, 2001, ISBN 3-446-15632-1 or “Anleitung zum Bau von Spritzgieβwerkzeugen” [Introduction to the Construction of Injection Moulds], Menges/Michaeli/Mohren, Munich, Vienna: Hanser, 1999, ISBN 3-446-21258-2.

After curing by irradiation with UV light, the coated surface of the coated polycarbonate film produced in this way then has the inventive combination of properties in terms of scratch resistance, solvent resistance and reduced oiling effect.

On account of the advantageous combination of properties of scratch resistance, solvent resistance and reduced oiling effect of the surfaces of the inventive polycarbonate films, these films are particularly suitable for production of 3D plastics parts, especially those which are obtained by film insert moulding processes. The surfaces of the plastics parts thus have the particular properties of the inventive films The present invention therefore further provides a 3D plastics part comprising the inventive coated polycarbonate film. In a particularly preferred embodiment, the 3D plastics part according to the present invention is obtainable by a film insert moulding process. Processes of this kind include the reverse coating, for example by injection moulding, of the inventive coated polycarbonate films with a thermoplastic polymer, especially with polycarbonate.

Therefore, the present invention further provides for the use of the inventive coated polycarbonate film for the production of plastics parts in film insert moulding processes. In a particularly preferred embodiment, the inventive use comprises the production of plastics parts for the automotive, transport, electrical, electronics and construction industries.

### EXAMPLES

Assessment Methods

Layer Thickness

The layer thickness of the coatings was measured by observing the cutting-edge in an Axioplan optical microscope manufactured by Zeiss. Method—reflected light, bright field, magnification 500x.

Assessment of Blocking Resistance

Conventional test methods as described, for instance, in DIN 51350 are insufficient to simulate the blocking resistance of rolled-up, pre-dried, coated films, and therefore the following test was employed: The coating materials were applied to Makrofol DE 1-1 (375 μm) with a conventional coating bar (target wet film thickness 100 μm). After a flash-off phase at 20° C. to 25° C. for 10 min, the coated films were dried in an air circulation oven at 110° C. for 10 min. After a cooling phase for 1 min, a commercial GH-X173 natur pressure-sensitive lamination film (from Bischof und Klein, Lengerich, Germany) was applied without creasing to the dried coated film with a plastic roller over an area of 100 mm×100 mm. Subsequently, the laminated film piece was subjected to a weight of 10 kg over the full area for 1 hour. Thereafter, the lamination film was removed and the coated surface was assessed visually.

Assessment of Pencil Hardness

The pencil hardness was measured analogously to ASTM D 3363 using an Elcometer 3086 Scratch boy (Elcometer Instruments GmbH, Aalen, Germany) under a load of 500 g, unless stated otherwise.

Assessment of Steel Wool Scratching

The steel wool scratching was determined by sticking a piece of No. 00 steel wool (Oskar Weil GmbH Rakso, Lahr, Germany) onto the flat end of a 500 g fitter's hammer, the area of the hammer being 2.5 cm×2.5 cm, i.e. approximately 6.25 cm². The hammer was placed onto the surface to be tested without applying additional pressure, such that a defined load of about 560 g was attained. The hammer was then moved back and forth 10 times in twin strokes. Subsequently, the stressed surface was cleaned with a soft cloth to remove fabric residues and coating particles. The scratching was characterized by haze and gloss values, measured transverse to the scratching direction, with a Micro HAZE plus (20° gloss and haze; Byk-Gardner GmbH, Geretsried, Germany). The measurement was effected before and after scratching. The differential values for gloss and haze before and after stress are reported as Δgloss and Δhaze.

Assessment of Solvent Resistance

The solvent resistance of the coatings was typically tested with isopropanol, xylene, 1-methoxy-2-propyl acetate, ethyl acetate, acetone, in technical-grade quality. The solvents were applied to the coating with a soaked cotton bud and protected from vaporization by covering. Unless stated otherwise, a contact time of 60 minutes at about 23° C. was observed. After the end of the contact time, the cotton bud is removed and the test surface is wiped clean with a soft cloth. The inspection is immediately effected visually and after gentle scratching with a fingernail.

A distinction is made between the following levels:
0=unchanged; no change visible; cannot be damaged by scratching.
1=slight swelling visible, but cannot be damaged by scratching.
2=change clearly visible, can barely be damaged by scratching.
3=noticeable change, surface destroyed after firm fingernail pressure.
4=significant change, scratched through to the substrate after firm fingernail pressure.
5=destroyed; the coating is already destroyed when the chemical is wiped away; the test substance cannot be removed (has eaten into the surface).

Within this assessment, the test is typically passed with the ratings of 0 and 1. Ratings of >1 represent a “fail”.

Assessment of Oiling Effect

The “oiling effect” is also referred to as the “Newton ring effect”. Newton rings occur as an irregular interference pattern on the surface of coated parts when they are viewed in reflection under white light. On a reflective, shiny surface, a light beam is reflected both at the outer surface of a coated component and at the surface of the coated substrate beneath. If a path difference in the region of λ/2 occurs between the two reflected beams of one wavelength, this wavelength is attenuated or even extinguished by interference, and the white light originally emitted is subject to local colour change in reflection. These patterns can also be detected as oscillations in the reflection spectrum of coated surfaces (coated films here). The intensity and frequency of these oscillations is a measure of the occurrence of the Newton ring effect.

The measurements used to determine the oiling effect are taken from transmission and reflection spectra which have been recorded with a spectrometer front STEAG ETA-Optik, CD-Measurement System ETA-RT. The direct reflection was measured at a viewing angle of 0°.
The index for the Newton rings was determined from the reflection spectra as follows:
mPV: maximum peak-valley ratio in % in the range of 400-650 nm.
mPV/2: amplitude of oscillation in %
R: reflection at the corresponding wavelength in %

Newton rings=mPV/2/R·1000

The wavelength ranges below 400 nm and above 650 nm are not considered because colour contrasts in these ranges are so small that no interference effects perceptible to the naked eye are visible.

### Example 1

### Production of a Coating Composition

25 g of poly(methyl methacrylate) (manufacturer: Aldrich, catalogue no. 182265, M_{w} 996 000 (GPS, figure from Aldrich) were dissolved in 142 g of 1-methoxy-2-propanol at 100° C. in about 5 h. The solution was cooled down to about 30° C. Separately, the following components were dissolved in 83 g of 1-methoxy-2-propanol at room temperature: 25 g of dipentaerythrityl penta-/hexaacrylate (DPHA, manufacturer: Cytec), 2.0 g of Irgacure 1000 (manufacturer: BASF), 1.0 g of Darocur 4265 (manufacturer: BASF), 0.0625 g of BYK 333 (manufacturer: BYK). This second solution was added to the polymer solution while stirring. The coating material was stirred at room temperature and with shielding from direct incidence of light at room temperature for another 3 h, dispensed and left to stand for 1 day. The yield was 270 g, the viscosity (23° C.) was 9060 mPas, the solids content was 19% by weight and the calculated double bond density in the solids content of the coating material was about 5.1 mol/kg.

### Example 2

### Production of a Coating Composition

Analogously to Example 1, Degalan M345 (PMMA; manufacturer: Evonik; M_{w} 180 000—figure from Evonik) was used to produce a coating composition. The yield was 275 g, the solids content was 19% by weight and the calculated double bond density in the solids content of the coating material was about 5.1 mol/kg.

### Example 3

### (Not in Accordance With the Invention) Production of a Coating Composition

Analogously to Example 1, Degalan M825 (PMMA; manufacturer: Evonik; M_{w} 80 000—figure from Evonik) was used to produce a coating composition. The yield was 280 g, the solids content was 19% by weight and the calculated double bond density in the solids content of the coating material was about 5.1 mol/kg.

### Example 4

### Coating of Films

The coating compositions according to Examples 1 to 3 were applied to a backing film, for example Makrofol DE 1-1 (Bayer MaterialScience AG, Leverkusen, Germany), by means of a slot coater from the manufacturer TSE Troller AG. The layer thickness of the backing film was 250 μm.

A further backing film was a co-extruded PC/PMMA film of the Makrofol® SR 253 type (Bayer MaterialScience AG, Leverkusen, Germany). The total layer thickness of the backing film was 250 μm, and the thickness of the PMMA layer 15 μm. The coating composition from Example 1 was applied to the PMMA side of the backing film by means of a slot coater.

As a third backing film, a co-extruded PC/PMMA film from the manufacturer MSK (Meihan Shinku Kogyo Co, Ltd., Japan) was used. The total layer thickness of the backing film was 250 μm, and the thickness of the PMMA layer 56 μm. The coating composition from Example 1 was applied to the PMMA side of the backing film by means of a slot coater.

Typical application conditions here were as follows:
web speed 1.3 to 2.0 m/min
wet coating material applied 20-150 μm
air circulation dryer 90-110° C., preferably in the region of the TG of the polymer to be dried.
residence time in the dryer 3.5-5 min.

The coating was effected roll to roll, meaning that the polycarbonate film was unrolled in the coating system. The film was conducted through one of the abovementioned application units and contacted with the coating solution. Thereafter, the film with the wet coating was run through the dryer. After leaving the dryer, the now dry coating was typically provided with a lamination film, in order to protect it from soiling and scratching. Thereafter, the film was rolled up again.

### Example 5

### Testing of Blocking Resistance

The coated sides of the non-UV-cured films produced in Example 4 were covered with a laminating film of the GH-X 173 A type (Bischof+Klein, Lengerich, Germany) and weighted down with an aluminium sheet of dimensions 4.5×4.5 cm² and a weight of 2 kg at about 23° C. for 1 h. Thereafter, the weight and the lamination film were removed and the surface of the coating was checked visually for changes.

The experiments showed that the coatings are blocking-resistant (no impression in the film) from a molecular weight of the polymethylmethacrylate of 100 000 or more.

### Example 6

### Forming of the Coated Films and Curing of the Coatings

The HPF forming tests were performed on an SAMK 360 system. The mould was electrically heated to 100° C. The film heating was undertaken by means of IR emitters at 240, 260 and 280° C. The heating time was 16 seconds. A film temperature of about 170° C. was attained. The forming was effected at a forming pressure of 100 bar. The forming mould was a heating/ventilation panel.

The appropriate film sheet was fixed at an exact position on a pallet. The pallet passed through the forming station into the heating zone and resided therein for the time set (16 s). In the course of this, the film was heated in such a way that the film briefly experienced a temperature above the softening point; the core of the film was about 10-20° C. colder. As a result, the film was relatively stable when it is run into the forming station.

In the forming station, the film was fixed by closing the mould over the actual mould; at the same time, the film was formed over the mould by means of gas pressure. The pressure hold time of 7 s ensured that the film was accurately formed by the mould. After the hold time, the gas pressure was released again. The mould opened and the formed film was run out of the forming station.

The film was subsequently removed from the pallet and could then be cured with UV light.

With the mould used, radii down to 1 mm were formed.

The UV curing of the inventive coating was executed with an evo 7 dr high-pressure mercury vapour lamp (ssr engineering GmbH, Lippstadt, Germany). This system is equipped with dichroitic reflectors and quartz discs, and has a specific power of 160 W/cm. A UV dose of 2.0 J/cm² and an intensity of 1.4 W/cm² were applied. The surface temperature was to reach >60° C.

The UV dose figures were determined with a Lightbug ILT 490 (International Light Technologies Inc., Peabody Mass., USA). The surface temperature figures were determined with temperature test strips of the RS brand (catalogue number 285-936; RS Components GmbH, Bad Hersfeld, Germany).

Results for the durability of the coatings which have been crosslinked using the conditions specified can be found in Table 1.

TABLE 1
Chemical resistance and scratch resistance of the coatings

| | | | | Total | | | Steel wool |
|---|---|---|---|---|---|---|---|
| | | | | thickness of | | Pencil | (manufacturer: |
| | | Thickness of | | the PMMA- | Solvent | hardness | Rakso, No. 00) |
| | Coating | the upper | | containing | IP/MPA/X/EA/Ac | 500 g | 560 g/10 DH |
| No. | material | coating | Backing film | layers | 1 h/RT | Mitsubishi | ΔG/ΔH |
| 1 | Example 1 | 5 μm | Makrofol DE | 5 μm | 0/0/0/0/0 | HB | 1/1 |
| | | | 1-1 | | | | |
| 2 | Example 1 | 7 μm | Makrofol DE | 7 μm | 0/0/0/0/0 | HB | 3/5 |
| | | | 1-1 | | | | |
| 3 | Example 1 | 12 μm | Makrofol DE | 12 μm | 0/0/0/0/0 | HB | 1/4 |
| | | | 1-1 | | | | |
| 4 | Example 1 | 17 μm | Makrofol DE | 17 μm | 0/0/0/0/0 | H | 5/5 |
| | | | 1-1 | | | | |
| 5 | Example 1 | 25 μm | Makrofol DE | 25 μm | 0/0/0/0/0 | H | 3/4 |
| | | | 1-1 | | | | |
| 6 | Example 1 | 4 μm | Makrofol | 19 μm | 0/0/0/0/0 | H | 3/5 |
| | | | SR253 | | | | |
| 7 | Example 1 | 6 μm | Makrofol | 21 μm | 0/0/0/0/0 | 2H | 1/4 |
| | | | SR253 | | | | |
| 8 | Example 1 | 5 μm | PC/PMMA | 61 μm | 0/0/0/0/0 | 4H | 4/5 |
| | | | film* | | | | |
| 9 | uncoated | — | Makrofol DE | — | 0/5/5/5/5 | 3B | 100/285 |
| | | | 1-1 | | | | |
| 10 | — | — | Makrofol | 15 μm | 0/5/5/5/5 | H | 142/399 |
| | | | SR253 | | | | |
| 11 | — | — | PC/PMMA | 56 μm | 0/5/5/5/5 | 3H | 85/267 |
| | | | film* | | | | |

*Manufacturer: MSK (JP)

Table 1 shows that the inventive uppermost coating with the inventive coating composition leads to a distinct improvement in pencil hardness and scratch resistance. The inventive coating led to very good solvent resistances of the films. Particularly notable is the solvent resistance of the final coating developed to acetone. Acetone, the most aggressive solvent for polycarbonate films, has almost no effect on the inventive final coating, even over a contact time of 1 hour (rating ≦1; scoring 0 to 5). This means that the solvent resistance for this coating is at the level of the best (but non-formable) hardcoat. Without the inventive upper coating, PC/PMMA coextrusion films are relatively hard but do not have adequate solvent resistance.

### Example 7

### Determination of the Refractive Index of the Coating

The refractive index n as a function of the wavelength of the samples was obtained from the transmission and reflection spectra. For this purpose, a film of the coating composition from Example 1 having a thickness of about 300 nm was spun onto quartz glass carriers. The transmission and reflection spectrum of this layer assembly was measured with a “CD-Measurement System ETA-RT” spectrometer from the manufacturer AudioDev, and then the layer thickness and the spectral profile of n were fitted to the measured transmission and reflection spectra in the range of 380-850 nm. This was done with the spectrometer's internal software and additionally required the refractive index data for the quartz glass substrate, which were determined beforehand in a blank measurement. The refractive indices for the cured coating materials are based on the wavelength of 589 nm and hence correspond to n_{D}^{°}.

TABLE 2
Refractive index

| Coating material | n_{D}²⁰ of the cured coating |
|---|---|
| Example 1 | 1.511 |

### Example 8

### Determination of the Intensity of the Rainbow Effect

A measure used for the rainbow effect was the number of Newton rings determined from reflection spectra. It was calculated from the maximum amplitude in the reflection spectrum between 400 nm and 650 nm. Reflection (R) and maximum amplitude (MA) were taken from the spectrum in per cent. In order to eliminate the unit, MA was divided by R at the same wavelength. In order to avoid decimal places, the value determined was multiplied by 1000.

TABLE 3
Rainbow effect/Newton rings

| | | | | Total | | Max. peak- | |
|---|---|---|---|---|---|---|---|
| | | | | thickness of | | valley value | |
| | | Thickness of | | the PMMA- | | (mPV) in the | Number of |
| | Coating | the upper | | containing | Reflection | range of 400 | Newton rings |
| No. | material | paint film | Backing film | layers | (R), % | nm to 650 nm | mPV/2000 R |
| 1 | Example 1 | 5 μm | Makrofol DE | 5 μm | 8.7 | 1.3 | 74 |
| | | | 1-1 | | | | |
| 2 | Example 1 | 7 μm | Makrofol DE | 7 μm | 8.9 | 0.7 | 38 |
| | | | 1-1 | | | | |
| 3 | Example 1 | 12 μm | Makrofol DE | 12 μm | 8.9 | 0.1 | 7 |
| | | | 1-1 | | | | |
| 4 | Example 1 | 17 μm | Makrofol DE | 17 μm | 8.9 | 0.1 | 6 |
| | | | 1-1 | | | | |
| 5 | Example 1 | 25 μm | Makrofol DE | 25 μm | 9.0 | 0.1 | 4 |
| | | | 1-1 | | | | |
| 6 | Example 1 | 4 μm | Makrofol | 19 μm | 8.7 | 0.4 | 21 |
| | | | SR253 | | | | |
| 7 | Example 1 | 6 μm | Makrofol | 21 μm | 8.9 | 0.2 | 12 |
| | | | SR253 | | | | |
| 8 | Example 1 | 5 μm | PC/PMMA | 61 μm | 9.2 | 0.3 | 14 |
| | | | film* | | | | |

*Manufacturer: MSK (JP)

The values thus determined were around or below 20 for the inventive coatings of numbers 3 to 8 in Table 3, whereas the non-inventive films of numbers 1 and 2 in Table 3, wherein the total thickness of the PMMA-containing layers was below 10 μm, show values of 30 or even higher and hence obvious oiling.

As the examples clearly showed, the inventive coated polycarbonate films have scratch-resistant and solvent-resistant surfaces with at least reduced oiling. Thus, the inventive films are of excellent suitability for production of mouldings of all kinds, especially by film insert moulding processes.

1-15. (canceled)

16. A coated polycarbonate film comprising a polycarbonate film beneath at least one polymethylmethacrylate-containing layer having a polymethylmethacrylate content of at least 40% by weight, wherein
the total layer thickness of the at least one polymethylmethacrylate-containing layer is at least 10 μm,
the uppermost layer of the at least one polymethylmethacrylate-containing layer is obtained by coating with a coating composition comprising
(a) at least one polymethylmethacrylate polymer or polymethylmethacrylate copolymer having a mean molar mass Mw of at least 100 000 g/mol in a content of at least 40% by weight of the solids content of the coating composition;
(b) at least one UV-curable reactive diluent in a content of at least 30% by weight of the solids content of the coating composition;
(c) at least one photoinitiator in a content of 0.1 to 10 parts by weight of the solids content of the coating composition; and
(d) at least one organic solvent,
where the proportion of ethylenically unsaturated groups is at least 3 mol per kg of the solids content of the coating composition.

17. The coated polycarbonate film as claimed in claim 16, comprising one polymethylmethacrylate-containing layer.

18. The coated polycarbonate film as claimed in claim 16, comprising two polymethylmethacrylate-containing layers.

19. The coated polycarbonate film as claimed in claim 18, comprising a polycarbonate/polymethylmethacrylate film having a coating obtained by coating with a coating composition atop the polymethylmethacrylate layer of the film.

20. The coated polycarbonate film as claimed in claim 19, wherein the co-extruded polymethylmethacrylate layer has a thickness of at least 15 μm.

21. The coated polycarbonate film as claimed in claim 16, wherein the polymethylmethacrylate polymer or polymethylmethacrylate copolymer (a) has a Vicat softening temperature VET to ISO 306 of at least 95° C.

22. The coated polycarbonate film as claimed in claim 16, wherein the polymethylmethacrylate copolymer (a) consists of 70% by weight to 99.5% by weight of methyl methacrylate and 0.5% by weight to 30% by weight of methyl acrylate

23. The coated polycarbonate film as claimed in claim 16, wherein the at least one UV-curable reactive diluent (b) comprises bifunctional, trifunctional, tetrafunctional, pentafunctional and/or hexafunctional acrylic and/or methacrylic monomers.

24. The coated polycarbonate film as claimed in claim 16, wherein the solvent (d) is selected from the group consisting of 1-methoxy-2-propanol, diacetone alcohol, 2,2,3,3-tetrafluoropropanol, and mixtures thereof.

25. The coated polycarbonate film as claimed in claim 16, wherein the solvent (d) comprises 1-methoxy-2-propanol.

26. A process for producing a coated polycarbonate film comprising the steps of:
(i) coating a polycarbonate film or a co-extruded polycarbonate/polymethylmethacrylate film with a coating composition comprising
(a) at least one polymethylmethacrylate polymer or polymethylmethacrylate copolymer having a mean molar mass Mw of at least 100 000 g/mol in a content of at least 40% by weight of the solids content of the coating composition;
(b) at least one UV-curable reactive diluent in a content of at least 30% by weight of the solids content of the coating composition;
(c) at least one photoinitiator in a content of 0.1 to 10 parts by weight of the solids content of the coating composition; and
(d) at least one organic solvent,
where the proportion of ethylenically unsaturated groups is at least 3 mol per kg of the solids content of the coating composition;
(ii) drying the coating;
(iii) optionally cutting the film to size and/or delaminating, printing and/or thermally or mechanically forming the film;
(iv) irradiating the coating with UV radiation to cure the coating, where the thickness of the at least one PMMA-containing layer after the drying step is at least 10 μm.

27. A 3D plastics moulding comprising the coated polycarbonate film as claimed in claim 16.

28. The 3D plastics moulding as claimed in claim 27, obtained by a film insert moulding process.

29. A method for production of plastics parts in film insert moulding processes comprising utilizing the coated polycarbonate film as claimed in claim 16.

30. A plastics part for the automotive, transport, electrical, electronics and construction industries comprising the coated polycarbonate film as claimed in claim 16.
